(19) United States
(12) Patent Application Publication
(10) Pub. No.: US 2025/0118227 A1
(43) Pub. Date: Apr. 10, 2025

(54) PIGGYBACK REPLACEMENT LABEL

(71) Applicant: Iconex LLC, Duluth, GA (US)

(72) Inventor: Timothy Darren Livingston, Corryton, TN (US)

(21) Appl. No.: 18/903,837

(22) Filed: Oct. 1, 2024

Related U.S. Application Data
(60) Provisional application No. 63/542,626, filed on Oct. 5, 2023.

(51) Int. Cl. G09F 3/02; G09F 3/10

(52) U.S. Cl. CPC G09F 3/02; G09F 3/10; G09F 2003/0201; G09F 2003/0222; G09F 2003/0229; G09F 2003/0267

(57) ABSTRACT

A roll or a sheet of label combinations is provided, each label combination includes a liner substrate and a label substrate. The label substrate includes a primary label and a secondary/removable label defined by a removable label die cut within the label substrate. The liner substrate includes a plurality of liner die cuts adjacent to, aligned with, and corresponding to a middle and sides of the removable label. A front side of the liner substrate includes a first release coating. A backside of the label substrate, which corresponds to a center lane of the label substrate, includes a second release coating. The backside of the label substrate further includes an adhesive coating at least a portion of which is applied over the second release coating that corresponds to the center lane of the removable label.

### RELATED APPLICATIONS

The present application is non-provisional application of Provisional App. No. 63/542,626 filed Oct. 5, 2023, entitled “Piggyback Replacement Label; the disclosure of which in its entirety is incorporated by reference herein.

### BACKGROUND

A piggyback label is a removable label defined within another primary label. The piggyback label is removed from the primary label after the primary label is adhered to a surface of an object. Often piggyback labels require three substrates, two liner substrates and a label substrate for the primary label and the removable label. The three substrates are believed necessary to provide sufficient structural support for label auto applications.

For example, a liner and face stock/label substrate, which includes a single liner die cut for the removable label, weakens the liner when the primary label is separated from the liner by leaving a hole in the liner waste; the hole in the liner waste corresponds to the removable label. A portion of the liner remains attached to the back of removable label when the primary label is separated from the liner with the removable label. The hole's location and size within the liner waste cause jams in a printer. The printer rewinds the waste liner, which is weakened by a large hole corresponding to the removable label and breaks resulting in jams in the waste rewinder of the printer. As a result, piggyback labels include an extra liner substrate consisting of a first liner with no holes (i.e., a waste liner) and a second liner corresponding to the removable label. This ensures the liner waste includes no holes and can be properly rewound by the printer.

### SUMMARY

In various embodiments, a piggyback replacement label, rolls of piggyback replacement labels, and method of manufacturing piggyback replacement labels are presented.

In an embodiment, a label combination is provided. The label combination includes a liner substrate and a label substrate. The label substrate includes a primary label and a secondary/removable label defined by a die cut within the label substrate. The liner substrate includes a plurality of liner die cuts, each liner die cut defining an area within the liner; each area is either adjacent to an outer edge of the removable label or corresponds to a center portion of the removable label. A front side of the liner substrate includes a first release coating. A backside of the label substrate, which corresponds to the center portion of the label substrate, includes a second release coating. The backside of the label substrate further includes an adhesive coating at least a portion of which is applied over the second release coating that corresponds to the center portion of the removable label.

### BRIEF DESCRIPTION OF THE DRAWINGS

FIG. 1 is a diagram illustrating a label combination for a piggyback replacement label, according to an example embodiment.

FIG. 2 is a diagram of a removable label separated from the label combination of FIG. 1, according to an example embodiment.

FIG. 3 is a diagram of a liner once separated from the label combination of FIG. 1, according to an example embodiment.

FIG. 4 is a diagram of roll of label combinations of FIG. 1, according to an example embodiment.

FIG. 5 is a diagram of another label combination for a piggyback replacement label, according to an example embodiment.

FIG. 6 is a diagram of still another label combination for a piggyback replacement label, according to an example embodiment.

FIG. 7 is a diagram of a label combination for a piggyback replacement label associated with fanfold labels, according to an example embodiment.

FIG. 8 is a diagram of a label combination for a piggyback replacement label associated with fanfold labels which are printed by a pin fed printer, according to an example embodiment.

FIG. 9 illustrates diagrams for a removable label associated with a label combination for fanfold labels, label combinations of a roll, and a waste liner after removal of the removable labels from a portion of a sheet of label combinations, according to an example embodiment.

### DETAILED DESCRIPTION

As used herein, the term and phrase “liner” and/or “liner substrate” may be used interchangeably and synonymously. Also, the phrases “face stock” and “label substrate” may be used interchangeably and synonymously herein and below.

Piggyback labels are useful in a variety of industries for which a single label substrate includes two or more independent labels defined therein with at least one of the independent labels removable for independent application. Manufacturers/Distributors of items shipped to stores or warehouses often find piggyback labels useful for item packages sent. The primary label identifies a shipping address placed on the package and the removable label identifies a store stock code or store item code. When a store receives the items in a package, the store can remove the independent label and apply it to a shelf above the package for easy viewing by store personnel and item restocking by the personnel within the store. Of course, there are a variety of other applications for which piggyback labels are useful.

Auto applicators/printers are used to apply the piggyback labels. A roll or web of the labels are fed into the auto applicator where the piggyback labels are custom imaged, separated from a liner, applied to a package, and the waste liner is rewound into a waste liner roll for disposal or recycling. Standalone printers are also fed a roll of the piggyback labels for custom imaging of the piggyback labels, each label is manually separated from the liner by personnel and the waste liner is rewound into a waster liner spool within the printer. Personnel hand apply the dispensed individual piggyback labels on object surfaces. Use of a single liner for piggyback labels has proved ineffective in the industry because the waste liners handled by both the auto applicators and the standalone printers break and result in jams during rewinding of the waste liner. Consequently, piggyback labels are manufactured with two liners along with extra adhesive coatings and release coatings needed because of the extra liner.

These issues are solved with the piggyback replacement labels and roll of such labels presented herein. Different embodiments and/or designs of piggyback labels are presented because of the various different manners in which the piggyback labels are used in the industry. In an embodiment, one or more piggyback labels are presented for standalone printer usage to ensure the waste liner is properly rewound and does not cause any printer jams.

The piggyback replacement labels presented here provide several advantages over conventional piggyback labels, include improved structural integrity of the liner waste, reduced likelihood of printer jams, and elimination of the need for a second liner substrate. The unique arrangement of liner die cuts allow for efficient separation of the removable label while maintaining the strength of the liner waste. Furthermore, the piggyback labels presented herein solve the aforementioned issues by utilizing strategically placed liner die cuts and a center lane release coating. This design maintains the structural integrity of the liner waste, preventing breakage and jams during printer rewinding, while still allowing for easy removal of the secondary label. The single liner design also reduces material costs and simplifies the manufacturing process.

In an embodiment, one or more piggyback labels are presented for fanfold piggyback labels, which are fed to pin feed printers. In an embodiment, one or more piggyback labels are presented for fanfold piggyback labels where the labels are fan folded and stacked after a roll or stack of piggyback labels are imaged/printed by the printers; the labels are separated from the liner by personnel from the fan folded stack. In an embodiment, one or more of the piggyback labels provided herein are used with auto applicators to ensure the waste liner does not cause jams in the waste liner rewound by the auto applications.

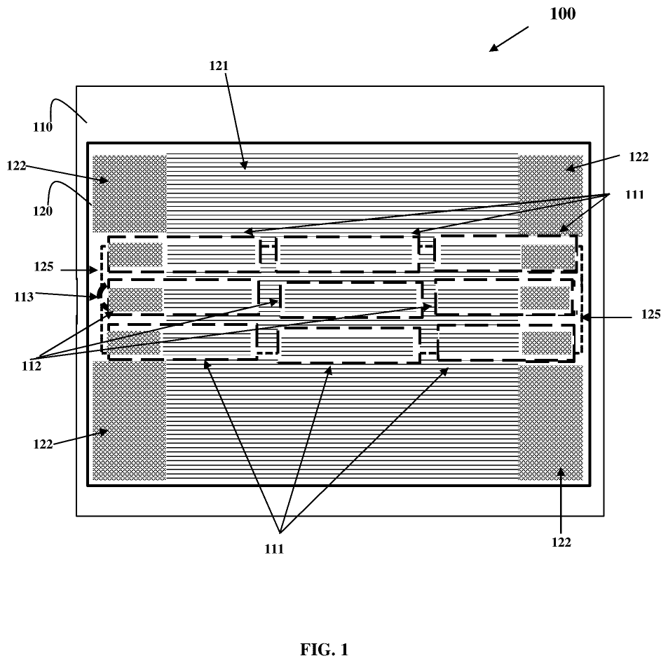

FIG. 1 is a diagram illustrating a label combination 100 for a piggyback replacement label, according to an example embodiment. The label combination 100 includes a liner 110 and a label substrate 120. The liner 110 includes a first release coating (not illustrated in FIG. 1 applied to a front side of the liner 110). The liner 110 further includes a plurality of die cuts 111, 112, and 113. These die cuts 111, 112, and 113 are align under a backside of the label substrate 120 that corresponds to a removable label defined by an area in the label substrate 120 made by die cut 125 in label substrate 120.

A center lane on the backside of the label substrate 120 is coated with a second release coating 121. The second release coating 121 does not extend to sides of the backside of the label substrate 120. Moreover, the second release coating 121 does not completely cover any liner die cut 111, 112, and 113 when the liner 110 is aligned and adhered to the label substrate 120 to form the label combination 100. After the center lane release coating 121 is applied to the backside of the label substrate 120, an adhesive coating 122 is flood coated on the backside of the label substrate 120. This means the center lane release coating 121 includes a portion of the adhesive coating 122 atop coating 121.

Die cut 113 is offset from an edge of liner 110 and is in line with a corresponding edge of label substrate 120. An end of die cut 113 has a shape of a semicircle. This creates a user tab, which can be grasped by a user when the label substrate 120 and pulled to separate the removable label defined by die cut 125 from the label substrate 120. The remaining portion of the label substrate 120, which remains adhered to the surface, represents the primary label of the label combination 100.

Even though the liner 110 lacks a die cut that corresponds to the label substrate die cut 125 for the removable label, the removable label separates from the label substrate because of the center lane release coating 117 and the liner die cuts 111, 112, and 113. This is due to the shape, placement, size, and orientation of the liner die cuts 111, 112, and 113 and the center lane release coating 121.

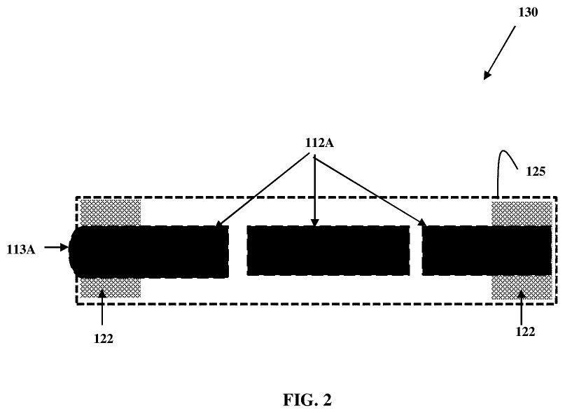

FIG. 2 is a diagram of a removable label 130 separated from the label combination of FIG. 1, according to an example embodiment. The label substrate. When the removable label 130 is separated from the label substrate 120 or removed from the primary label only three portions 112A of liner 110 remains on the backside of the removable label 130. Tab portion 113A also remains on the backside of the removable label 130. Notice that six areas defined by the liner die cuts 111 remain as part of the liner 110 and are not separated when the removable label 130 is separated from the primary label. Also notice the placement on the backside of the removable label 130 of the adhesive coating 122 on side portions of the removable label 130. This provides sufficient tack to securely adhere the removable label 130 to a surface of an object once the removable label 130 is separated from the primary label. Moreover, remaining liner portions 112A do not adversely impact the tack of the backside of the removable label 130, since they are small in size and are centered within the adhesive areas 122 on opposing sides of the removable label 130. Furthermore, some adhesive 122 remains atop release coating 121 when removable label 130 separates from the primary label/label substrate 120 and the liner 110 such that adhesive 122 is also present in the white areas (as illustrated in FIG. 2) between liner portions 112A on the backside of removable label 130.

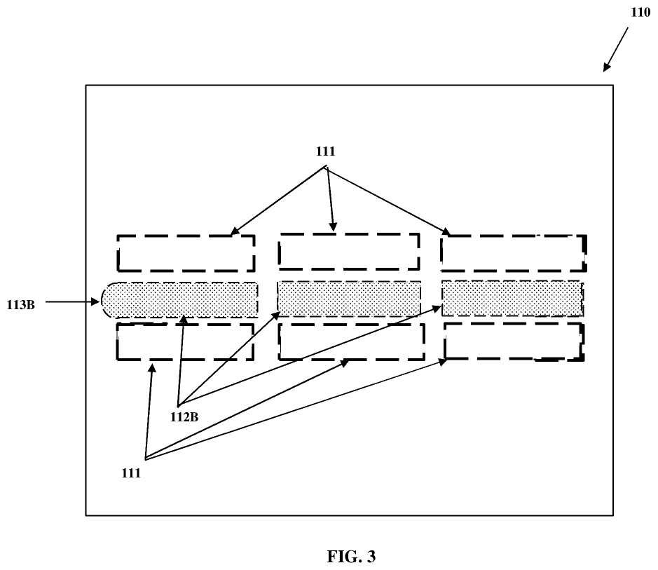

FIG. 3 is a diagram of a liner 110 once separated from the label combination 100 of FIG. 1, according to an example embodiment. Once the label substrate 120 is separated from the liner 110, just holes 112B and 113B remain in the liner 110 (i.e., liner waste 110). The size of the holes 112B and 113B are small and spaced evenly apart from the sides of liner waste 110. This provides structural integrity to the liner waste 110 with little loss of surface area and weight. As a result, and auto applicator rewinder can rewind the liner waste 110 back into a waste roll without breaking the liner waste 110 and without jamming the rewinder.

Additionally, a standalone printer can dispense label combinations 100 with the label substrate 120 separated from the liner 110 and the waste liner 110 with holes 112B and 113B rewound by the printer into a waste spool without causing printer jams. This is because the waste liner 110 retains sufficient structural strength and balance to prevent the waste liner 110 from breaking during a printer rewind of the waste liner 110.

Also notice that areas defined by liner die cuts 111 (six areas shown in FIG. 3) remain as a portion of the liner waste 110. This is a substantial improvement over conventional approaches for which a hole at least the size of a given removable label remains in conventional liner waste, which can cause liner breakage and can create on off balance liner waste roll when an auto applicator machine or a standalone printer attempts to rewind the waste roll.

Liner waste 110 retains a significant amount of more liner substrate than does any conventional approach resulting in substantial strength that prevents liner breakage when the label substrate 120 is separated from liner 110 and the liner waste 110 is wound into a roll by an auto applicator machine or a standalone printer. At the same time, removable label 130 retains sufficient adhesive 122 when separated from the primary label to ensure that removable label 130 adheres to a desired surface.

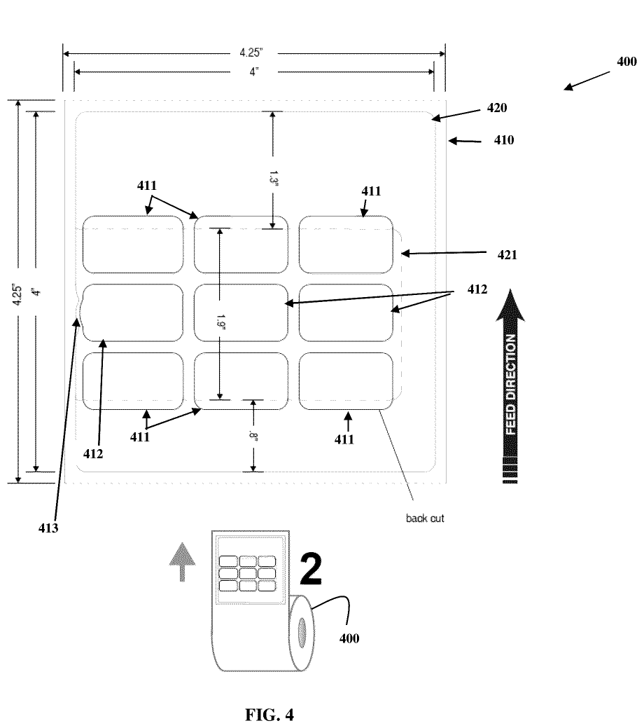

FIG. 4 is a diagram of roll 400 of label combinations 100 of FIG. 1, according to an example embodiment. It is noted that dimensions for the label combination 100 is shown as an example embodiment since other sized label combinations 100 are foreseeable without departing from the teachings provided herein.

The label combination 100 includes a liner substrate 410 and a label substrate 420. A first die cut 421 defines an area within the label substrate 410 for the removable and independent label 200. The liner substrate 410 includes six equally sized die cuts 411 and 412. Die cuts 411 include two rows of three die cuts 411, each row is adjacent to three sides of the first die cut 421. A top row of die cuts 411 is adjacent to a top, right, and left sides of the first die cut 421. A bottom row of die cuts 411 is adjacent to a time, right, and left sides of the first die cut 421. Die cuts 412 are placed in between the top row of die cuts 411 and the bottom row of die cuts 411. Thus, die cuts 412 are adjacent to a top row of die cuts 411, a bottom row of die cuts 411, a left side of first die cut 421, and a right side of die cut 421. Die cuts 412 are situated and aligned within the liner to corresponding to a center lane of a backside of removable label 200. Notably, a single die cut 412 includes a tab shape 413 that is a semicircle in shape protruding out to an edge of the label substrate 120.

In an embodiment, each label combination 100 within roll 400 is separated by a sense mark imaged or printed on a front side of the label substrate 120. This permits the auto application machine or standalone printer to identify each of the individual label combinations 100 within roll 400.

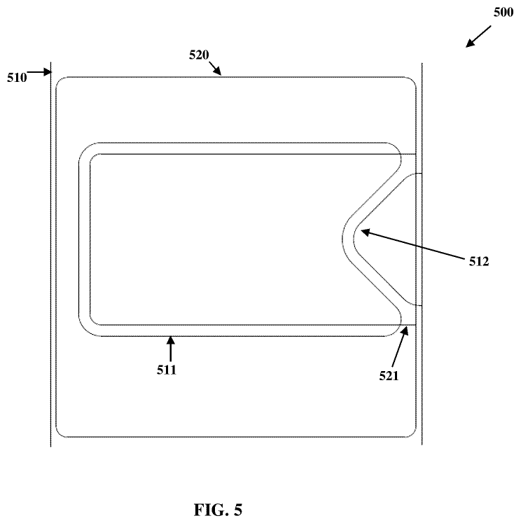

FIG. 5 is a diagram of another label combination 500 for a piggyback replacement label, according to an example embodiment. In an embodiment, label combination 500 is used with standalone printer applications to ensure the waste liner rewound by the printer does not break or jam when the label substrate 520 is separated from the liner 510 and after the primary label and independent removable label are imaged by the printer. The label combination 500 includes a liner 510 and a label substrate 520. The liner 510 includes two die cuts 511 and 512. The label substrate 520 includes a single die cut 521, which defines a removable area from the label substrate 120 for a removable and independent label.

Die cut 511 extends beyond and past three sides of die cut 521 when the liner 510 and label substrate 520 are aligned and adhered together as label combination 500. Die cut 512 extends past a portion of a rightmost side of label substrate 120. Die cut 512 is proximate to a top rightmost edge of die cut 521 and proximate to a bottom left most edge of die cut 521.

Die cut 511 defines an area within the liner 510 that is substantially larger than the area defined within the liner 510 by die cut 512. Die cuts 511 and 513 are separated by an area defined within the liner 510 which has no die cuts. Die cut 512 is a curved triangular shape or convex shape with the apex of the triangle oriented towards a concave shaped portion of die cut 511. Die cut 511 includes one rightmost side that is curved and concaved in shape, with remaining portions of the die cut 511 having a rectangular shape.

When label substrate 520 is imaged by a printer and dispensed, an individual peels label substrate 520 off of liner 510. The area defined by die cut 512 in the liner 510 remains with the liner waste and does not separate from the liner 510, whereas the area defined by die cut 511 detaches from liner 510 leaving a hole in the liner waste corresponding to the shape of die cut 511 as illustrated in FIG. 5. A standalone printer that rewinds the liner waste after separation of label substrate 520 for liner 510 does not jam because the area remaining in the liner waste corresponding to die cut 512 provided edge strength to the liner waste such that the liner waste will not break and cause a jam.

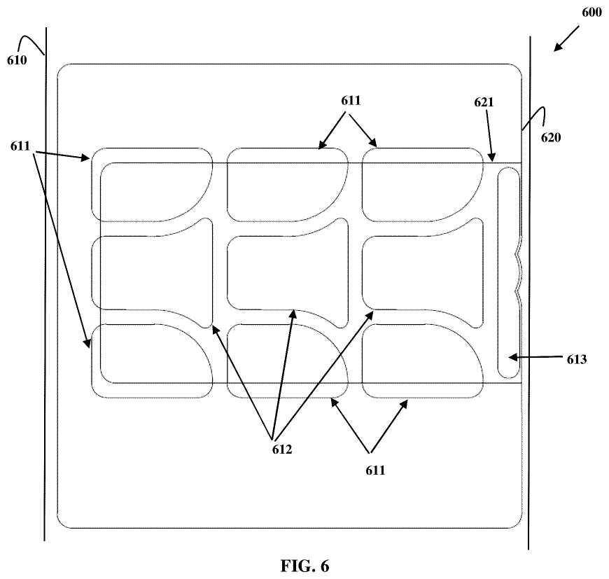

FIG. 6 is a diagram of still another label combination 600 for a piggyback replacement label, according to an example embodiment. In an embodiment, label combination 600 is used with standalone printer applications to ensure the waste liner rewound by the printer does not break or jam when the label substrate 620 is separated from the liner 610 and after the primary label and independent removable label are imaged by the printer.

The label combination 600 includes a label substrate 620 and a liner 610. The label substrate 620 includes a first die cut 621, which defines an area within the label substrate for a removable and independent label. The areas of the label substrate 620 not corresponding to the removable and independent label defines a primary label within the label substrate.

The liner 610 includes a plurality of different shaped and sized die cuts 611, 612, and 613. A top row and bottom row of die cuts 611 have a same shape, the shape is a rounded rectangle with two of the four corners rounded more than the other two corners, as illustrated in FIG. 6. The top and bottom rows of die cuts 611 extend beyond a top, a bottom, right side, and left side of the first die cut 621. In an embodiment, each row includes three separate die cuts 611.

Each die cut 611 defines an area within the liner 610. When the liner 610 and label substrate 620 are aligned and affixed together as the liner combination 600, a first portion of the area of each die cut 611, which aligns to and overlaps other portions of the area defined by first die cut 621, is larger than a second portion of the corresponding area that extends beyond and aligns outside of first die cut 612.

The liner 610 includes a middle row of die cuts 612 of a same size and shape. The size and shape of die cuts 611 are different from the size shape of die cuts 612. In an embodiment, the die cut 612 is a bell shaped die cut oriented with the bottom of the bell shape towards die cut 613. The area defined by each die cut 612 is larger than the area defined by each die cut 611. In an embodiment, there are three die cuts 612 only a left most die cut 612 extends beyond a left most side of first die cut 621. In an embodiment, die cuts 612 are aligned substantially along a center horizontal lane of an area defined by die cuts 621. In an embodiment, die cuts 612 are a middle row die cuts situated between a top and a bottom row of die cuts 611.

Die cut 613 is adjacent to a rightmost side of first die cut 621. Die cut 613 includes a rectangular shape with two rounded ends associated with two sides of the rectangular shape, and a convex and concave portion of a center of one of the sides, which are not rounded. The two rounded ends are adjacent to but do not extend beyond a top side and bottom side of first die cut 621. The convex and concave portion is adjacent to the rightmost side of first die cut 621.

When a standalone printer images and dispenses label combination 600 and the label substrate 620 is separated from the liner 610, the liner waste includes holes in the liner 610 corresponding to die cuts 612. The portions of the liner 610 corresponding to die cuts 611 and 613 remain as part of the liner. That is, a backside of the removable and independent label includes portions of the liner 610 corresponding to die cuts 612. Because the liner waste does not include any holes for die cuts 611 and more particularly 613, the liner waste is structurally sound and balanced and is wound by the standalone printer into a liner waste spool with breakage of the liner waste and without any liner waste jams. Furthermore, a sufficient amount of adhesive remains on the backside of the removable and independent label to permit that label to be adhered to an object or surface.

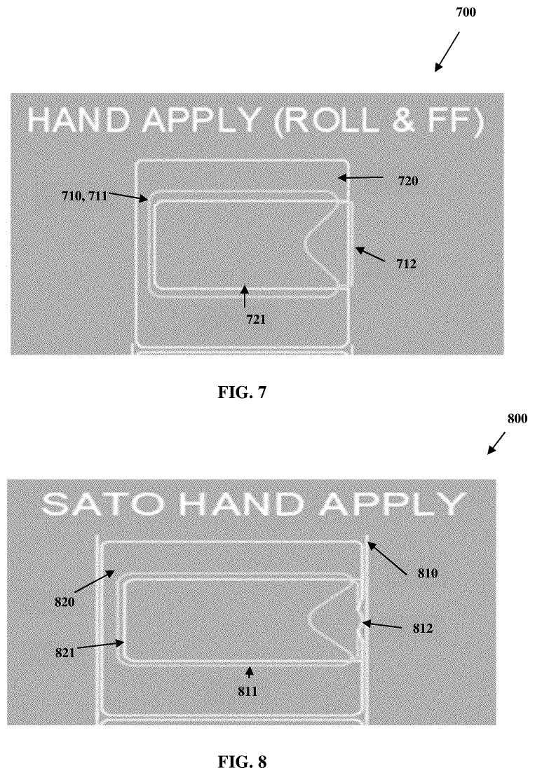

FIG. 7 is a diagram of a label combination 700 for a piggyback replacement label associated with fanfold labels, according to an example embodiment. In an embodiment, a sheet of label combinations 700 includes 12 individual label combinations organized within the sheet as 4 rows of 3 label combinations 700. In an embodiment, the sheets are fan folded in a box and fed to a standalone printer, the printer images the sheets with custom indicia for each primary and independent and removable label of the 12 label combinations 700 on the sheet. In an embodiment, a roll of the label combinations 700 is fed to a standalone printer where they are imaged and dispensed, the label substrate 720 is separated from the liner 710 and the liner waste is wound into a liner waste spool by the printer. In an embodiment, as sheets of the label combinations 700 are imaged by the printer, the sheets are fan folded into a stack in front of the printer.

Label combination 700 includes a liner substrate 710 and a label substrate 720. The label substrate 720 includes a first die cut 721 that defines an area within the label substrate 720 which defines the removable and independent label. The liner substrate 710 includes a first die cut 711 and a second die cut 712. The first die cut 711 has a similar shape, size, and orientation relative to the removable and independent label as was described above with die cut 511 of label combination 500 in FIG. 5. The second die cut 712 is three lines of die cuts, a first line die cut that corresponds to a rightmost side of the first die cut 721, and second and third lines that extend from top and bottom ends the first line die cut 721 back to intersect a top right corner and a bottom right corner of the first die cut 711.

When the removable label is separated from the primary label in label combination 700 the area defined by the first die cut 711 of the liner 710 remains on the liner 710. The liner area enclosed within the three line die cuts 712 and extending to the top rightmost and bottom rightmost corner of first die cut 711 is removed from the liner 710 create a small hole in the liner defined by the corresponding area.

FIG. 8 is a diagram of a label combination 800 for a piggyback replacement label associated with fanfold labels which are printed by a pin fed printer, according to an example embodiment. In an embodiment, sheets of label combinations 800 are pin fed to a printer, the printer images the primary and removable labels of the sheets and fan fold stacks the printed label combinations 800 in front of or behind of the printer.

Label combination 800 includes a liner substrate 810 and a label substrate 820. The label substrate 820 includes a first die cut 821 that defines an area within the label substrate 820 corresponding to the removable and independent label. The liner 810 includes a first die cut 811, which is similar in size and shape to the first die cut 711 of label combination 700 and liner 810 includes a second die cut 812 which is similar to what was discussed above for the line die cuts 712 of label combination 700. However, unlike line die cuts 712, a first line die cut 812, which is adjacent and aligned to a rightmost side of die cut 821, includes a convex and concave portion in the center of the first line die cut 812. The convex and concave portion creates a protruding tab for removal of the independent label from the primary label of the label combination 800.

When the removable label is separated from the primary label in label combination 800 the area defined by the first die cut 811 of the liner 810 remains on the liner 710. The liner area enclosed within the three line die cuts 812 and extending to the top rightmost and bottom rightmost corner of first die cut 811 is removed from the liner 810 create a small hole in the liner 810 defined by the corresponding area.

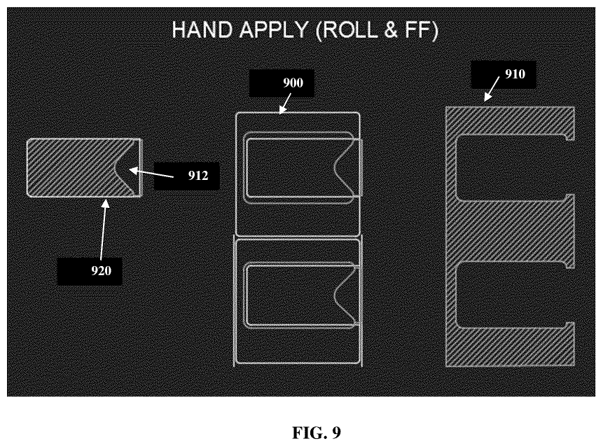

FIG. 9 illustrates diagrams for a removable label 920 associated with a label combination 700/800 for fanfold labels, label combinations 700/800 of a roll 900, and a waste liner 910 after removal of the removable labels 700/800 from a portion of a sheet of label combinations 700/800 or roll 900 of label combinations 700/800, according to an example embodiment.

The leftmost diagram of FIG. 9 illustrates a removable label separated from a primary label in label combination 700 or 800. The diagonal lines are intended to illustrate an adhesive coating, which was originally applied to the backside of the label substrate overtop of a center lane release coating. The front side of the liner was coated with release coating, such that because backside of the removable label 920 does not retain the liner in the area defined by the diagonal lines, the area includes the adhesive for applying the label to an object or a surface.

The middle diagram shows a roll 900 or a sheet 900 of label combinations 700 or 800 with the corresponding liner die cuts, 711, 811, 712, or 812 and the label die cut 721 or 821 for each combination 700 or 800. The rightmost diagram shows the waste liner 910 produced when the primary labels or sheets of the label substrate are removed from the liner substrate.

A variety of different label combinations were illustrated. Each label combination includes an optimized design for one or more of: auto applicator machines, standalone printers, fan fold labels, pin feed printers with fan folding output sheets, and hand apply labels. The label combinations represent improvements and optimizations over conventional piggyback labels based on the locations, orientations, and shapes of liner die cuts made in the liner substrate relative to the removable label's die cut within the label substrate.

In an embodiment, the front side of the liner includes a release coating that exhibits a first peel force in grams per inch whereas the center lane release coating on a portion of the backside of the label substrate exhibits a second peel force in grams per inch that is approximately three or more times higher than the first peel force in grams per inch. In an embodiment, the first peel force is 6-8 grams/inch, and the second peel force is 20-25 grams/inch.

In an embodiment, at least one of the two release coatings is a non-silicone based release coating. In an embodiment, the release coating applied to the front side of the liner substrate is a different type of release coating from that which is applied to the center lane of the backside of the label substrate.

In an embodiment, the label combination is manufactured on a press at stations which make die cuts in the label and liner substrates, applies a release coating to the front side of liner, applies the center lane release coating to the backside of the label substrate, applies adhesive coating to the backside of the label substrate, aligns the front side of the liner with the backside of the label substrate, and presses the liner to the label substrate to form the label combinations discussed herein and above. In an embodiment, a web of the liner substrate and label substrate is unwound from a roll processed through the press at the stations and rewound into a roll that includes a plurality of individual label combinations. In an embodiment the web of the liner and label substrates are cut into sheets and fan folded into a carton for shipping to businesses, which use standalone printers for fan folding and hand apply label applications. In an embodiment, a station of the press further prints or images sense marks along the web to delineate between labels or sheets of the labels. The senser marks read by printers to identify an individual label within a roll or to identify an individual sheet from the web, each sheet includes a plurality of individual labels.

In alternative embodiments, the shape, size, and arrangement of the liner die cuts may be varied to accommodate different label sizes or specific printer requirements. For instance, the number of die cuts may be increased or decreased, or their shapes may be altered from rectangular to circular, triangular, or other geometric forms. The spacing between die cuts could also be adjusted to optimize structural integrity for different label sizes. Additionally, the release coatings may be applied in different patterns, such as a grid or alternating strips, or using various materials to achieve specific release characteristics for different applications. For example, silicone-based coatings could be used for general-purpose labels, while fluoropolymer-based coatings might be employed for labels exposed to harsh chemicals or extreme temperatures.

Furthermore, and in some embodiments, the adhesive coating could be applied in various patterns or densities to optimize adhesion for different label applications. For instance, a stronger adhesive could be used around the edges of the removable label for improved durability, while a lighter adhesive could be used in the center for easier removal. The center lane release coating could also be modified in width or pattern, such as using a wider center lane for larger labels or a discontinuous pattern for specialized release characteristics. Additionally, the liner die cuts could be designed with different depths or partial cuts to further fine-tune the balance between label removability and liner integrity.

In an embodiment, a front side of the label substrate includes a thermally activated coating, which when exposed to heat by a thermal printer causes the front surface of the label substrate to be imaged with custom indicia. In an embodiment, a front side of the label substrate includes a laser or dot matrix coating, which permits laser and dot matrix printers to print custom indicia on the front surface of the label substrate.

Although the present invention is described with reference to certain preferred embodiments thereof, variations and modifications of the present invention can be affected within the spirit and scope of the following claims.

1. A label combination, comprising:
a liner substrate comprising a plurality of liner die cuts and a first release coating disposed on a front side of the liner substrate; and
a label substrate comprising label die cut defining a removable label, a second release coating disposed on a center lane portion of a backside of the label substrate, and an adhesive coating disposed on the backside of the label substrate at least a portion of which is disposed over the second release coating;
wherein the plurality of liner die cuts are aligned to correspond with a middle and sides of the removable label.

2. The label combination of claim 1, wherein when the label substrate is separated from the liner substrate, at least one liner die cut remains as a portion of the liner substrate and an additional liner die cut remains adhered to the backside of the label substrate in areas that at least correspond to middle of the removable label.

3. The label combination of claim 2, wherein the at least one liner die cut that remains as a portion of the liner substrate is a single liner die cut, 6 liner die cuts, or 7 liner die cuts.

4. The label combination of claim 3, wherein one of the additional liner die cut that remains adhered to the backside of the label substrate is a single liner die cut or 3 liner die cuts.

5. The label combination of claim 1, wherein the first release coating exhibits a first peel force of 6-8 grams per inch and the second release coating exhibits a second peel force of 20-25 grams per inch.

6. The label combination of claim 1, wherein the first release coating is a different type of release coating from that which is associated with the second release coating.

7. The label combination of claim 6, wherein one of the first release coating or the second release coating is a non-silicone based release coating.

8. The label combination of claim 1, wherein at least one of the plurality of liner die cuts includes a tab shape protruding to an edge of the label substrate.

9. The label combination of claim 1, wherein a front side of the label substrate comprises a thermally activated coating for thermal printing.

10. The label combination of claim 1, wherein a front side of the label substrate comprises a laser or dot matrix coating for laser or dot matrix printing.

11. The label combination of claim 1, further comprising a sense mark printed on a front side of the label substrate to delineate between individual label combinations.

12. A roll of piggyback labels, comprising:
a plurality of label combinations wound into a roll, each label combination comprising:
a liner substrate;
a label substrate adhered to the liner substrate;
wherein the label substrate comprises a primary label and a removable label defined by a label die cut;
wherein the liner substrate comprises a plurality of liner die cuts aligned with the removable label; and
wherein when the label substrate is separated from the liner substrate, at least one liner die cut remains as a portion of the liner substrate and at least one additional liner die cut remains adhered to a backside of the removable label.

13. The roll of piggyback labels of claim 12, wherein the liner substrate comprises a first release coating on a front side of the liner substrate.

14. The roll of piggyback labels of claim 12, wherein the label substrate comprises a second release coating disposed on a center lane portion of a backside of the label substrate.

15. The roll of piggyback labels of claim 14, wherein the label substrate further comprises an adhesive coating disposed on the backside of the label substrate at least a portion of which is disposed over the second release coating.

16. The roll of piggyback labels of claim 12, wherein the plurality of liner die cuts are aligned to correspond with a middle and sides of the removable label.

17. The roll of piggyback labels of claim 12, wherein the at least one liner die cut that remains as a portion of the liner substrate provides structural integrity to a liner waste when the label substrate is separated from the liner substrate.

18. The roll of piggyback labels of claim 12, wherein the roll further comprises at least one sense mark to delineate between individual label combinations in the roll.

19. A label combination, comprising:
a liner substrate comprising at least one liner die cut; and
a label substrate comprising a removable label defined by a label die cut;
wherein the at least one liner die cut is aligned with the removable label;
wherein when the label substrate is separated from the liner substrate, a portion of the liner substrate defined by the at least one liner die cut remains adhered to a backside of the removable label.

20. The label combination of claim 19, wherein the liner substrate comprises a release coating on a front side of the liner substrate, and the label substrate comprises an adhesive coating on a backside of the label substrate.
